(19) United States
(12) Patent Application Publication
(10) Pub. No.: US 2004/0001097 A1
(43) Pub. Date: Jan. 1, 2004

(54) Glove virtual keyboard for baseless typing

(76) Inventors: Frank Zngf, Taichung (TW); Stan Huang, Taoyuan Hsien (TW)

Correspondence Address: Cooper & Dunham LLP, 1185 Avenue of the Americas, New York, NY, 10036, US

(21) Appl. No.: 10/187,098

(22) Filed: Jul. 1, 2002

(51) Int. Cl. G09G 5/00

(52) U.S. Cl. 345/773

(57) ABSTRACT

A data glove input device, serving as a virtual keyboard and enabling ten-finger-typing, has two palm bodies with glove fingers. A tilt sensor is mounted on the middle phalanx of each respective glove finger. It is used to detect the falling in one of multiple tilt angle ranges of the phalanx and to select a specific item from items in a particular column. The same tilt sensor for item selecting can also be used to validate a selection by detecting a tilt angle peak pulse. Multiple contact pads and multiple switch buttons are mounted on the lateral sides of glove fingers except the thumbs, and each of them, which is able to be touched by the thumb, is to switch the same signal selected by a tilt angle or a finger to represent another different item. Accordingly, the data glove can be finger tip uncovered and allows baseless virtual typing.

### BACKGROUND OF THE INVENTION

1. Field of the Invention

The present invention relates to an alphanumeric input device for an information processing system, and more particularly to a data glove used as a virtual keyboard enabling ten-finger-typing for a word processor.

2. Description of Related Art

For input data to an information processing device such as a computer, a cell phone, a personal digital assistant (PDA) or the like, a keyboard is commonly used. When the user presses a key on the keyboard, a corresponding signal will be sent to the information processing system so as to input the corresponding data item. The keyboards for different devices have different sizes and different configurations which provide different function capacities and different levels of operability. But, among a variety of keyboards providing full service, the conventional QWERTY keyboard is still the most popular one currently because of the users' habits and its relative good performances in typing operability and typing speed.

However, the conventional QWERTY keyboard is bulky with a rigid structure, such that a base with a large space is needed to place on and type on, and it is inconvenient to carry and to use. Moreover, the user is prone to pressing wrong keys in rapid typing because precision positioning of fingers on the keyboard in typing is a requirement. To overcome the above shortcomings, a data glove input device as a virtual keyboard is an alternative solution to mitigate or obviate the aforementioned problems.

A system disclosed in U.S. Pat. No. 6,304,840 uses a data glove as a virtual keyboard enabling ten-finger-typing. The bend angle at the proximal interphalangeal joint detected by a bending sensor is used to decode a particular row of the keyboard. Each finger controls one or more columns. An abduction/adduction sensor is used to discriminate columns operated by the same finger. The end parts of the fingers of the glove are uncovered.

### SUMMARY OF THE INVENTION

The main objective of the invention is to provide an alternative data glove input device, which enables ten-finger-typing and is compact and user-friendly. Another objective is that finger tips can be exposed such that, for doing things requiring touches of finger tips, they can be more dexterous than with entire fingers being covered. Furthermore, to type even without a base provides an alternative typing method for conditions such as when it is difficult to find a location to place user's hands on or when the user feels uncomfortable for finger tips to hit a solid surface.

The glove virtual keyboard has two palm bodies. Five glove fingers are formed on each palm body to fit with a hand of the user. A validating sensor is mounted on each respective glove finger of each palm body for validation of an item selection. Furthermore, there is a tilt sensor mounted on a phalanx of each respective glove finger of each body. The tilt sensor is used to detect the falling of one of multiple tilt angle ranges of the phalanx to select a specific item from items in the corresponding column of the glove finger. The same tilt sensor for item selection can also serve as a validating sensor by generating a tilt angle pulse, such that another physical validating sensor for each glove finger is no longer needed. With such a design, a user's finger tips can be exposed and the hands can even remove from a base area to type in the air.

For more item selection capability, multiple contact pads mounted on lateral sides of glove fingers but not on the thumb, are used to discriminate multiple columns operated by the same finger. If a contact pad is pressed by the thumb, the item from another column is selected, which is different from the one selected with the contact pad not being pressed. Multiple switch buttons, mounted on the lateral sides of the glove index fingers, are used to distinguish function keys, symbol keys and numeral keys in higher rows from the keys in lower rows. With a switch button being pressed by the corresponding thumb, a function key, symbol key or numeral key is selected when a particular finger is selected. With such a device, the user can efficiently and quickly input data into an information processing system.

Other objects, advantages and novel features of the invention will become more apparent from the following detailed description when taken in conjunction with the accompanying drawings.

### BRIEF DESCRIPTION OF THE DRAWINGS

FIG. 1 is a top plan view of a right body of a glove virtual keyboard in accordance with the present invention;

FIG. 2 is a top plan view of a left body of the glove virtual keyboard in accordance with the present invention;

FIG. 3 is an operational side plan view of the left body of the glove virtual keyboard in FIG. 2;

FIG. 4 is an operational side plan view of the left body of the glove virtual keyboard in FIG. 2 showing that a contact pad is pressed to change the item selection;

FIG. 5 is a top plan view of the right body of the glove virtual keyboard in FIG. 1 showing the item arrangement on the right body;

FIG. 6 is a top plan view of the left body of the glove virtual keyboard in FIG. 2 showing the item arrangement on the left body; and

FIG. 7 is an operational side plan view of the second embodiment of a left body of a glove virtual keyboard in accordance with the present invention; and

FIG. 8 is a schematic drawing of the arrangement of the items on a conventional QWERTY keyboard.

### DETAILED DESCRIPTION OF PREFERRED EMBODIMENT

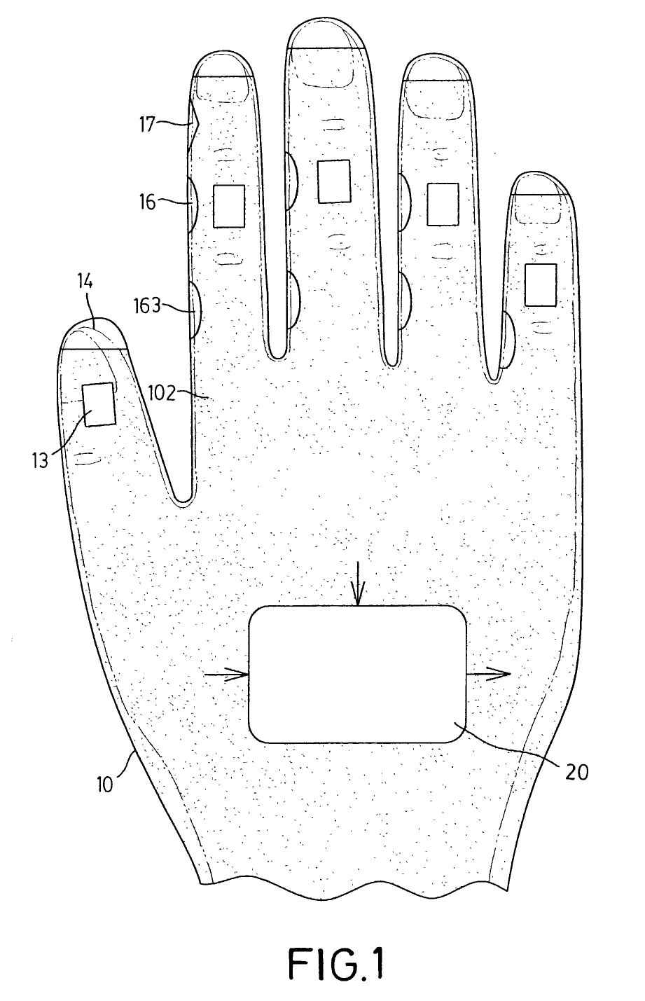

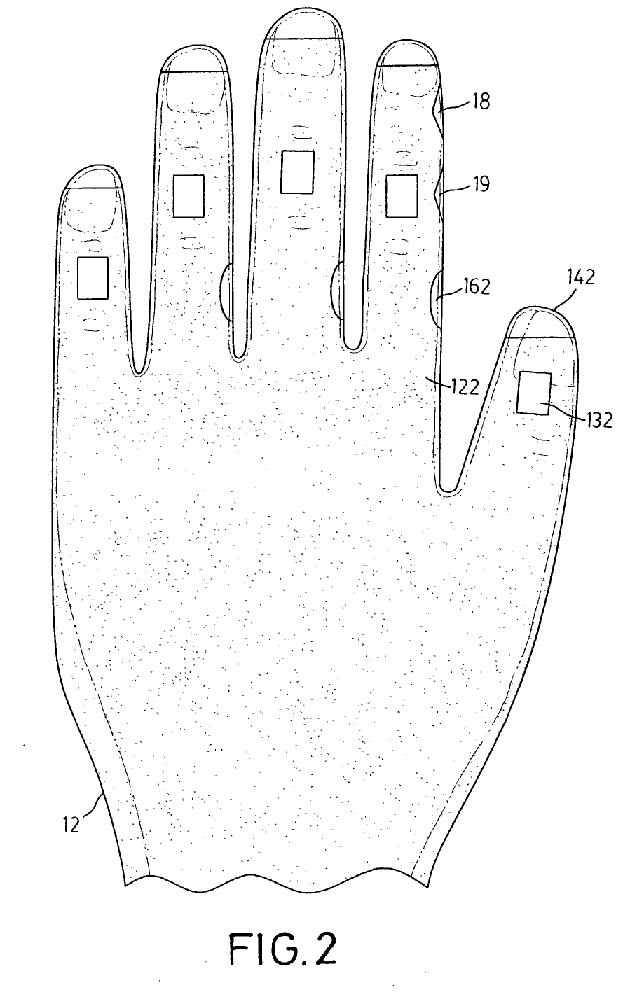

With reference to FIGS. 1 and 2, a glove virtual keyboard in accordance with the present invention comprises two palm bodies (10,12). Multiple glove fingers (102,122) are mounted on each respective palm body (10,12) so as to fit the hands of a user. A validating sensor (14,142) is mounted on each respective glove finger (102,122) of each palm body (10,12), and in one of the embodiments, a validating sensor (14,142) is mounted on the tip of each glove finger (102,122). When a validating sensor (14,142) is pressed onto an object, a signal will be generated to validate the selected item. A tilt sensor (13,132) is mounted on each respective glove finger (102,122) of each palm body (10,12) to detect the tilt angle of the corresponding finger of the user relative to the horizontal plane. In preference, each tilt sensor (13,132) is mounted on the middle phalanx of a glove finger (102,122). The falling in one of the multiple ranges of the tilt angle determines a selection of a specific data item from items in a column of the keyboard. When a finger tilts or bends to a specific tilt angle and the corresponding validating sensor (14,142) is pressed, the tilt angle of the corresponding finger will be measured by the tilt sensor (13,132) and the angle is classified as one of multiple ranges to represent a particular item. Consequently, a specific function item is selected and validated to input the item into the computer.

Multiple contact pads (16,162,163) are mounted on the glove fingers (102,122) of the palm bodies (10,12). In practice, each glove finger (102,122) may have several contact pads (16,162,163) mounted thereon except at the glove thumbs. When one of the contact pads (16,162,163) is kept pressed, a finger tilts to a specific angle and the validating sensor is pressed (14,142), the signals from the contact pad and the tilt sensor together determine the selection of a corresponding item in a column different from the item selected with the contact pad not pressed.

Multiple switch buttons (17,18,19), which are mounted on the glove fingers (102,122), are used to switch to higher row keys of items of numerals, symbols and function keys. In practice, the switch buttons (17,18,19) comprise a function switch button (17), a symbol switch button (18) and a numeral switch button (19). The function switch button (17) is mounted at the index glove finger (102) of the right palm body (10). The symbol switch button (18) and the numeral switch button (19) are mounted at the index glove finger (122) of the left palm body (12).

A signal processing unit (20) is mounted on one of the palm bodies (10,12) and is electrically connected with the validating sensors (14,142), the tilt sensors (13,132), the contact pads (16,162,163), the switch buttons (17,18,19) and an information processing device such as a computer, a cellular phone or a PDA. The signal processing unit (20) receives and processes the signals sent from the validating sensors (14,142), the tilt sensors (13,132), the contact pads (16,162,163) and the switch buttons (17,18,19), and sends the processed signals to the information processing device. In practice, the signal processing unit (20) can be connected to the information processing device with or without using wires.

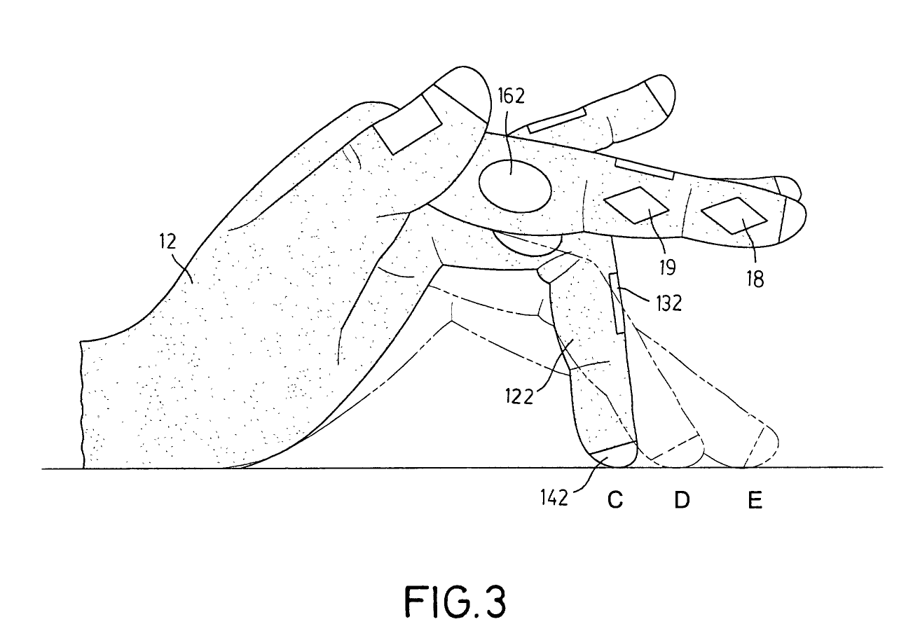

With reference to FIG. 3, when the user wants to input a data item to the information processing device with the glove virtual keyboard, the user puts the palm bodies (10,12) and tilts a finger to a specific tilt angle. For example, if the user wants to input an “E” into the information processing device, the user extends the middle finger of the left hand and presses the corresponding validating sensor (142) onto an object such as a book on a table top, a handrest of a chair or a leg of the user. After receiving a validation signal transmitted from the validating sensor (142) and a tilt angle for selection from the tilt sensor (132), the signal processing unit (20) processes the two signals and inputs a letter “E” to the information processing device. Accordingly, the user can input “D” and “C” letters to the information processing device, respectively, by tilting the finger to a larger and an even larger angles.

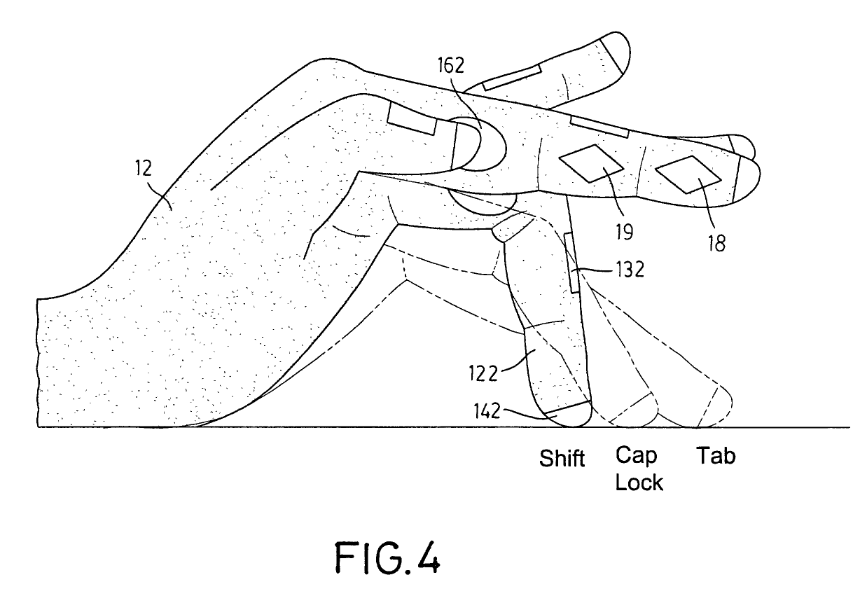

With reference to FIG. 4, when the contact pad (162) is kept pressed, the contact pad (162) will transmit a signal to the signal processing unit (20), such that the signal sent out from the signal processing unit (20) will change the selection of the original item to an item from a different column. To switch the signal for selecting an item from another column, a user can press a contact pad mounted on the glove finger corresponding to the input finger such as the contact pad on the middle finger shown in FIGS. 3 and 4. Alternatively, as shown in FIG. 4, the user can press, for easier positioning of fingers, the contact pad (162) just mounted on the index glove finger (122) even when the user inputs data using the middle finger. Accordingly, the input items with the middle finger are switched to “Tab, Cap Lock, Shift” from “E, D, C”, with respectively the same tilt angles as shown in FIGS. 3 and 4. For the same operational process, a user can use the same contact pad (162) to switch the selections of items from the column with “R, F, V” to the column with “T, G, B”.

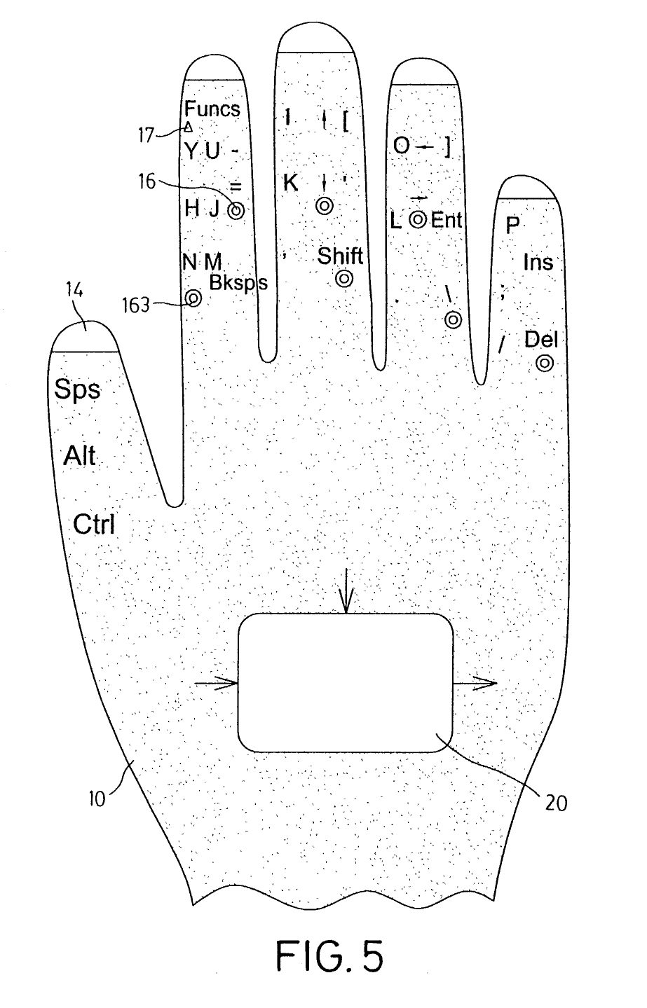

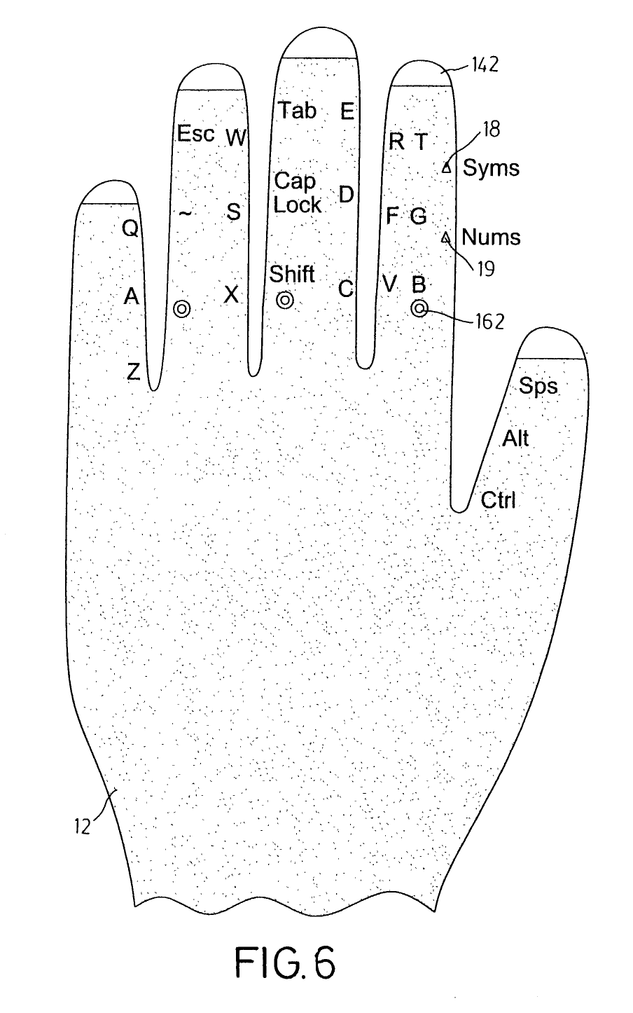

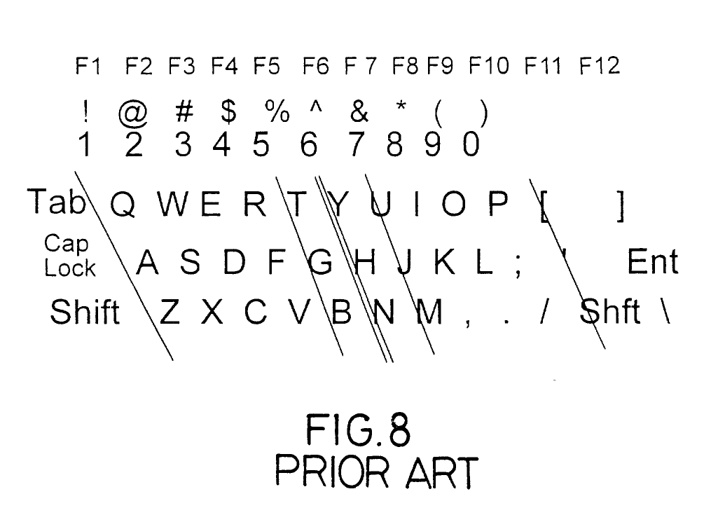

With reference to FIGS. 5, 6 and 8, the data items on the glove fingers (102,122) can be arranged according to the key arrangement of the conventional QWERTY keyboard. Accordingly, the user can have a good start for using the novel glove virtual keyboard. Additionally, because the selected item from the glove virtual keyboard is determined by the use of each finger and the tilt angle, a correct input depends only on the control of the tilt angle. In a conventional QWERTY keyboard, when a correct finger is used, the wrong column can be chosen, but such condition will not occur in the typing using this glove virtual keyboard. Comparing to typing on a QWERTY keyboard, which depends on precise positioning of each finger, the method for typing with this invention may not need to be so precise to be correct.

To input function keys such as F1, F2, F3, . . . , the function switch button (17) is kept pressed with the thumb of right hand, except this thumb, the validating sensor (14,142) on each one of the other nine fingers, then can be pressed to select and validate a particular function key. The selection of a specific function key item is determined by the finger used to validate the input. Nine fingers are not enough for decoding all of the function keys, such that some of the fingers are each used to select two or multiple functions by tilting the selecting finger at different angles. Similarly, when the symbol switch button (18) or the numeral switch button (19) is kept pressed with the thumb of left hand, and the validating sensor (14,142) on a specific finger is then pressed, respectively, a specific symbol or a specific numeral will be selected for input. In practice, each switch button (17,18,19) is designed to operate in two modes, i.e., a pressing mode or a switch mode. The pressing mode is that the switch is ON only while the button (17,18,19) is remained pressed by the thumb. The switch mode is that a switch button (16,17,18) is ON after it is quickly pressed on and released, it is OFF only after it is again pressed on and released.

Because the glove virtual keyboard is worn on the user's hands, there is no need for a base to support the keyboard. The condition of an object for the fingers to type on with this glove keyboard is less restricted than that with the conventional keyboard. It is even possible that a user can type without a base.

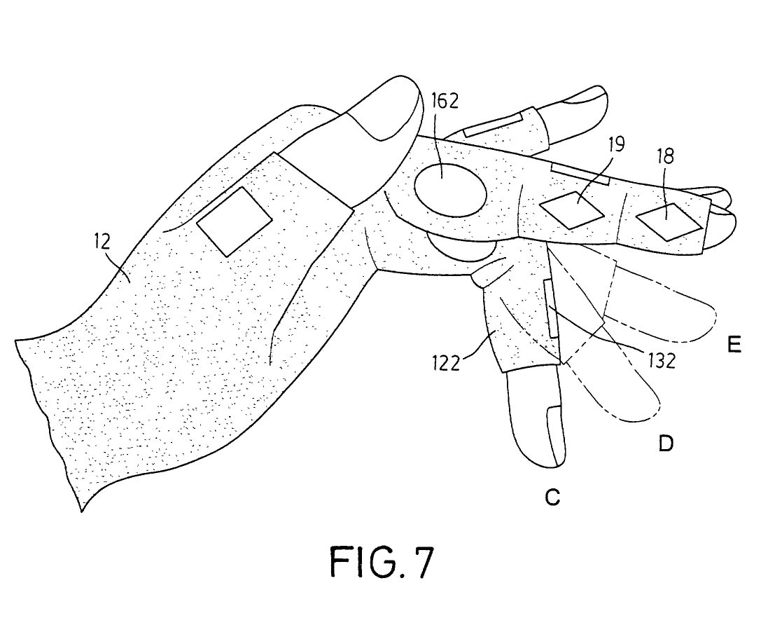

With reference to FIG. 7, finger tips of glove fingers (102,122) are not covered. The validating sensor (14,142) is functionally combined into the tilt sensor (13,132) on each glove finger. A validating signal will be produced when a peak pulse of the angle vs. time curve is detected by the tilt sensor. The way to generate the peak pulse in the typing procedure is described as follows. During the typing using this glove virtual keyboard, the user tilts the phalanx with a tilt sensor to an angle for selecting an item. After the tilt angle falling into the range defined for the selection of a specific item, the phalanx then quickly tilts downward and moves back. A peak pulse is then generated for validation, such that the input of an item is completed. With such a design, it can be observed that if a finger is pressed on a table, very similar to what is usually done to push down a key in typing with a conventional keyboard, the tilt sensor on the middle phalanx of the finger will generate a noticeable peak pulse accordingly. If hands are circulated in the air, with a little more caution, it is also not difficult to generate a noticeable validating peak pulse at a selected tilt angle by controlling the corresponding finger of the user.

With the function of validating sensors being combined into tilt sensors, this glove for typing shows the advantages as follows.

1. No extra physical validating sensor than the tilt sensors is needed and the number of parts of the glove is small.

2. With this glove, to type without a base, i.e., to type in the air, is possible, because there is no need of an object for finger tips to strike on. (3) The fingers of glove can be made with finger tips uncovered. Thus, the fingers of the user will not be hampered from doing things such as to scratch itching, to feel the texture of cloth, to pick a needle and so on.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A glove virtual keyboard comprising:
two palm bodies each formed with multiple glove fingers;
a tilt sensor mounted on a phalanx of each respective glove finger of each palm body, each tilt sensor is adapted for detecting a tilt angle of the phalanx relative to the horizontal plane, and the tilt angle is classified as a falling in one of the multiple ranges to determine selecting a specific data item; and
a signal processing unit to receive and to process signals from the palm bodies and to send signals to a computer.

2. The glove virtual keyboard as claimed in claim 1 further comprising:
multiple contact pads mounted on the glove fingers except the thumb of a palm body, each of the contact pads is adapted to be pressed by the corresponding thumb to cooperate with the tilt sensor to determine selecting an item from a different column.

3. The glove virtual keyboard as claimed in claim 1 further comprising:
multiple switch buttons mounted on the sides of the glove index fingers, the switch buttons include:
a function switch button adapted to be pressed by the corresponding thumb to cooperate with a glove finger to determine selecting a function item;
a symbol switch button adapted to be pressed by the corresponding thumb to cooperate with a glove finger to determine selecting a symbol item; and
a numeral switch button adapted to be pressed by the corresponding thumb to cooperate with a glove finger determine selecting a numeral item.

4. The glove virtual keyboard as claimed in claim 3, wherein a switch button can be operated as it is in the activated state only while the switch button remains pressed.

5. The glove virtual keyboard as claimed in claim 3, wherein a switch button can be operated as it is in the activated state after the switch button being quickly pressed and released and being deactivated for a following pressing with a releasing action.

6. The glove virtual keyboard as claimed in claim 1 further comprising:
a validating sensor mounted on each respective glove finger of each palm body.

7. The glove virtual keyboard as claimed in claim 6, wherein the validating sensor is mounted on the tip of the glove finger, a validating signal is generated when pressed.

8. The glove virtual keyboard as claimed in claim 6, wherein the validating sensor is functionally combined into the corresponding tilt sensor at the glove finger, with which a validating signal is generated while a tilt angle peak pulse is detected.

9. The glove virtual keyboard as claimed in claim 1, wherein the signal processing unit is connected by wires to a computer.

10. The glove virtual keyboard as claimed in claim 1, wherein the signal processing unit is connected wirelessly to a computer.
